(19) United States
(12) Patent Application Publication
(10) Pub. No.: US 2014/0183359 A1
(43) Pub. Date: Jul. 3, 2014

(54) DIGITAL RATE METER AND RADIATION MONITORING SYSTEM USING DIGITAL RATE METER

(71) Applicant: Kabushiki Kaisha Toshiba, Minato-ku (JP)

(72) Inventors: Arumi TAMARU, Kanagawa (JP); Mitsuru Oikawa, Saitama (JP); Minoru Iwabuchi, Tokyo (JP); Yoshimi Maekawa, Saitama (JP)

(73) Assignee: Kabushiki Kaisha Toshiba, Minato-ku (JP)

(21) Appl. No.: 14/096,181

(22) Filed: Dec. 4, 2013

(30) Foreign Application Priority Data
Dec. 28, 2012 (JP) 2012-288588

(51) Int. Cl. G01T 1/15

(52) U.S. Cl. CPC G01T 1/15
USPC 250/336.1

(57) ABSTRACT

An embodiment of a digital rate meter is connected to a digital detection unit that measures radiation based on a detector signal output from a radiation detector and transmits, for each transmission period, a transmission signal including a count value. The digital rate meter has a reception section that receives the transmission signal including the count value; a count extraction section that extracts, for each transmission period, the count value and outputs an extraction count value; a pulse generation section that converts, for each transmission period, the extraction count value output into a pulse train of a corresponding pulse number and outputs the obtained pulse train; a rate calculation section that performs rate calculation based on the extraction count value to calculate a dose rate; and a recorder output section that outputs the dose rate.

### CROSS REFERENCE TO RELATED APPLICATION

This application is based upon and claims the benefits of priority from the prior Japanese Patent Application No. 2012-288588, filed in the Japanese Patent Office on Dec. 28, 2012, the entire content of which is incorporated herein by reference.

### FIELD

Embodiments of the present invention relate to a digital rate meter used for radiation measurement and a radiation monitoring system using the digital rate meter.

### BACKGROUND

In general, a digital rate meter and a radiation monitoring system using the digital rate meter monitor a dose rate in real time. In such a radiation monitoring system, the real time dose rate can be calculated by applying time constant processing (rate calculation) to a radiation count obtained from a detector.

There is known a pulse rate meter including a counter for counting a cumulative pulse number every predetermined time of pulses input from a sensor, a counting rate processing section for receiving an output of the counter to calculate a pulse counting rate, a timer for outputting a reference clock to the counting rate processing section and the counter, a switch input section for controlling operation of the processing section, and a display section for displaying a result processed in the processing section. The counter, the timer, the processing section, the switch input section, and the display section are formed by a logic circuit (see, for example, Patent Document 1: Japanese Patent Application Laid-Open Publication 2002-341037).

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a block diagram illustrating a configuration of a first embodiment of a digital rate meter according to the present invention;

FIG. 2 is a block diagram illustrating a configuration of a pulse generation section of FIG. 1;

FIG. 3 is a diagram illustrating a control operation of the pulse generation section of FIG. 1;

FIG. 4 is a block diagram illustrating a configuration of a second embodiment of the digital rate meter according to the present invention;

FIG. 5 is a diagram illustrating an example of an output status of a transmission status determination section of FIG. 4;

FIG. 6 is a diagram illustrating another example of the output status of the transmission status determination section of FIG. 4;

FIG. 7 is a block diagram illustrating a configuration of the transmission status determination section in a third embodiment of the digital rate meter according to the present invention;

FIG. 8 is a diagram illustrating an example of a processing operation to be performed by the transmission status determination section of FIG. 7;

FIG. 9 is a diagram illustrating a count value extraction operation in a fourth embodiment of the digital rate meter according to the present invention;

FIG. 10 is a block diagram illustrating a configuration of the pulse generation section in a fifth embodiment of the digital rate meter according to the present invention;

FIG. 11 is a diagram illustrating an example of a control operation to be performed by the pulse generation section of FIG. 10;

FIG. 12 is a diagram illustrating another example of the control operation to be performed by the pulse generation section of FIG. 10;

FIG. 13 is a diagram illustrating still another example of the control operation to be performed by the pulse generation section of FIG. 10;

FIG. 14 is a block diagram illustrating a configuration of the pulse generation section in a sixth embodiment of the digital rate meter according to the present invention;

FIG. 15 is a block diagram illustrating a configuration of an embodiment of the radiation monitoring system using the digital rate meter according to the present invention; and

FIG. 16 is a block diagram illustrating a configuration of a radiation monitoring system according to a conventional technology.

### DETAILED DESCRIPTION

In a conventional radiation monitor using an analog detector, the analog detector and a counting rate meter (analog counting rate meter) are connected by a coaxial cable. In facilities where radiation needs to be managed, there is a case where a “count value of radiation dose” (hereinafter, referred to merely as “count value”) is required for the purpose of managing radiation density in addition to real-time dose rate measurement, or when the count value itself needs to be measured. In such a case, the counting rate meter using a radiation detector incorporates therein a pulse height discrimination circuit section, so that hardware provided in a central control room distanced from an installation site of the radiation detector is altered so as to output a count value before time constant processing calculation (rate calculation), and other calculations are carried out using the output count value.

However, since an output signal from the radiation detector is a weak signal, it is often the case in the analog counting rate meter that noise is mixed in the output signal while the transmitted output signal reaches the central control room to cause a pulse-shape discrimination section provided in the central control room to generate an error count. This poses a problem in that a correct dose rate cannot be obtained.

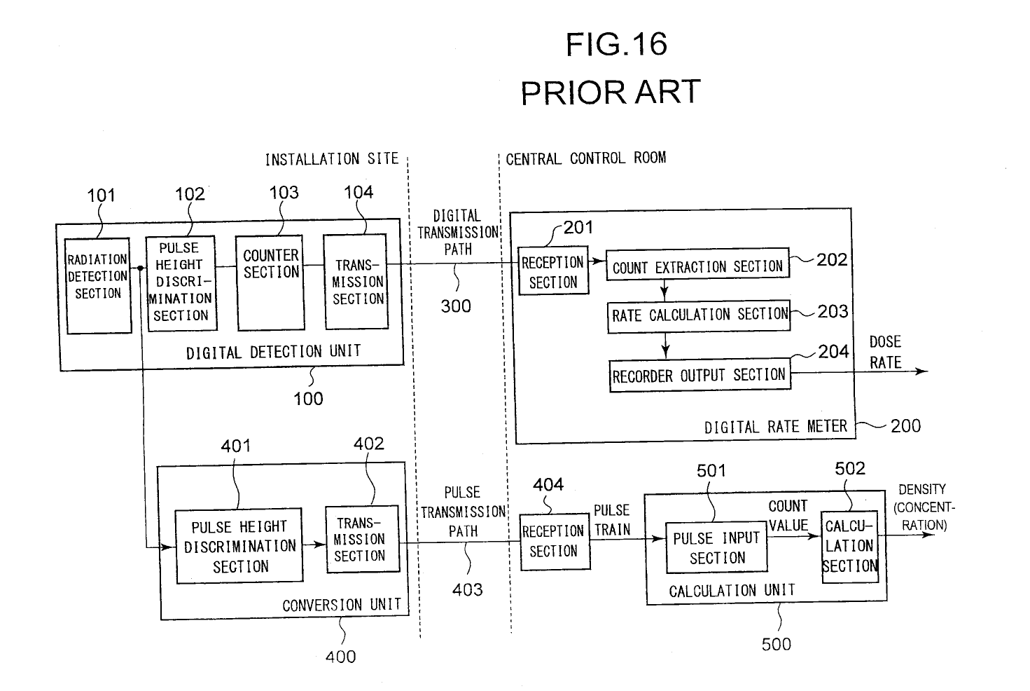

FIG. 16 illustrates an example of configurations of a conventional digital detection unit 100 and a conventional digital rate meter 200. By the digital detection unit 100 installed in an installation site (detection unit installation site), a transmission signal is digitized as described below.

In the digital detection unit 100, a radiation detection section 101 detects radiation. The detected radiation is discriminated in a pulse height discrimination section 102, and the detector signal that has passed through the pulse height discrimination section 102 is counted by a counter section 103. The count value (radiation pulse number) of detector signal output from the pulse height discrimination section 102 is digitized by the counter section 103. A transmission section 104 transmits a transmission signal including the count value to the digital rate meter 200 through a digital transmission path 300.

The digital rate meter 200 includes a reception section 201 that receives the transmission signal, a count extraction section 202 that extracts the count value from the transmission signal, a rate calculation section 203 that performs rate calculation of the dose rate based on the counter value, and a recorder output section 204 that outputs outside the dose rate value. With the above configuration, the dose rate is output from the digital rate meter 200.

In a case where a radiation density is managed, there are required the following components in order to output the density outside. That is, as illustrated in FIG. 16, it is necessary to additionally connect an external conversion unit 400 (constituted by a pulse height discrimination section 401 and a transmission section 402) to a monitor terminal connected to the radiation detection section 101 at the detection unit installation site and further additionally connect a pulse transmission path 403 to the conversion unit 400. The transmission section 402 is connected to a detection unit installation side end of the pulse transmission path 403.

Moreover, as illustrated in FIG. 16, it is necessary to additionally provide, on the central control room side distanced from the detection unit installation site, a reception section 404 to be connected to the other end of the pulse transmission path 403 and a calculation unit 500 having a pulse input section 501 that inputs thereto a pulse train from the reception section 404 and a calculation section 502 that calculates density using a count value output from the pulse input section 501.

In general, the counting rate meter used as a radiation monitor is required to output a dose rate which is obtained by applying rate calculation to the above-mentioned count value (radiation pulse number). Moreover, in a case where the radiation density needs to be managed or where a counting rate is calculated by accumulating the count value itself for a long-time basis, there is required a cumulative count value which is a cumulative value of the pulse number that has passed through the pulse height discrimination circuit, etc., in addition to the dose value as an instantaneous value.

However, there is a difference in characteristics (due to variation in components or variation in circuit adjustment) between the two pulse height discrimination sections 102 and 401 provided in the digital detection unit 100 and conversion unit 400 as illustrated in FIG. 16, respectively. Accordingly, there occurs a difference between the count value calculated for rate calculation by the digital rate meter 200 and count value calculated for density calculation by the calculation unit 500. As a result, it takes time and labor to inspect and adjust the two pulse height discrimination sections 102 and 401 with high accuracy so as not to generate the difference.

An object of embodiments of the present invention is to provide a digital rate meter capable of accurately measuring a radiation dose rate and a radiation count value and a radiation monitoring system using the digital rate meter.

In order to achieve the object, according to an embodiment of the present invention, there is provided a digital rate meter communicably connected to a digital detection unit that measures radiation based on a detector signal output from a radiation detector and transmits, for each transmission period, a transmission signal including a count value, the digital rate meter comprising: a reception section that receives the transmission signal including the count value; a count extraction section that extracts, for each transmission period, the count value from the transmission signal received by the reception section and outputs an extraction count value based on the extracted count value; a pulse generation section that converts, for each transmission period, the extraction count value output from the count extraction section into a pulse train of a corresponding pulse number and outputs the obtained pulse train;

a rate calculation section that performs rate calculation based on the extraction count value to calculate a dose rate; and a recorder output section that outputs the dose rate in a predetermined output form.

According to another embodiment, there is provided a radiation monitoring system comprising: a digital detection unit that detects radiation and measures the radiation; and a digital rate meter to be communicably connected to the digital detection unit, wherein the digital detection unit includes: a radiation detection section that detects the radiation and outputs the detected radiation in a form of a detector signal; a pulse height discrimination section that shapes, based on the detector signal output from the radiation detection unit, the detector signal having a level exceeding a predetermined threshold level into a pulse and outputs the pulse; a counter section that counts the number of pulses output from the pulse height discrimination section; and a transmission section that transmits a transmission signal including a count value counted for each transmission period, and the digital rate meter includes: a reception section that receives the transmission signal including the count value; a count extraction section that extracts, for each transmission period, the count value from the transmission signal received by the reception section and outputs an extraction count value based on the extracted count value; a pulse generation section that converts, for each transmission period, the extraction count value output from the count extraction section into a pulse train of a corresponding pulse number and outputs the obtained pulse train; a rate calculation section that performs rate calculation based on the extraction count value to calculate a dose rate; and a recorder output section that outputs the dose rate in a predetermined output form.

A digital rate meter according to embodiments of the present invention and a radiation monitoring system using the digital rate meter will be specifically described below with reference to the drawings. Throughout the description, the same reference numerals are given to the same or similar parts, and the repeated description will be omitted. The following embodiments will be described taking as an example a digital rate meter in plant equipment for nuclear power plant and a radiation monitor system using the digital rate meter.

### First Embodiment

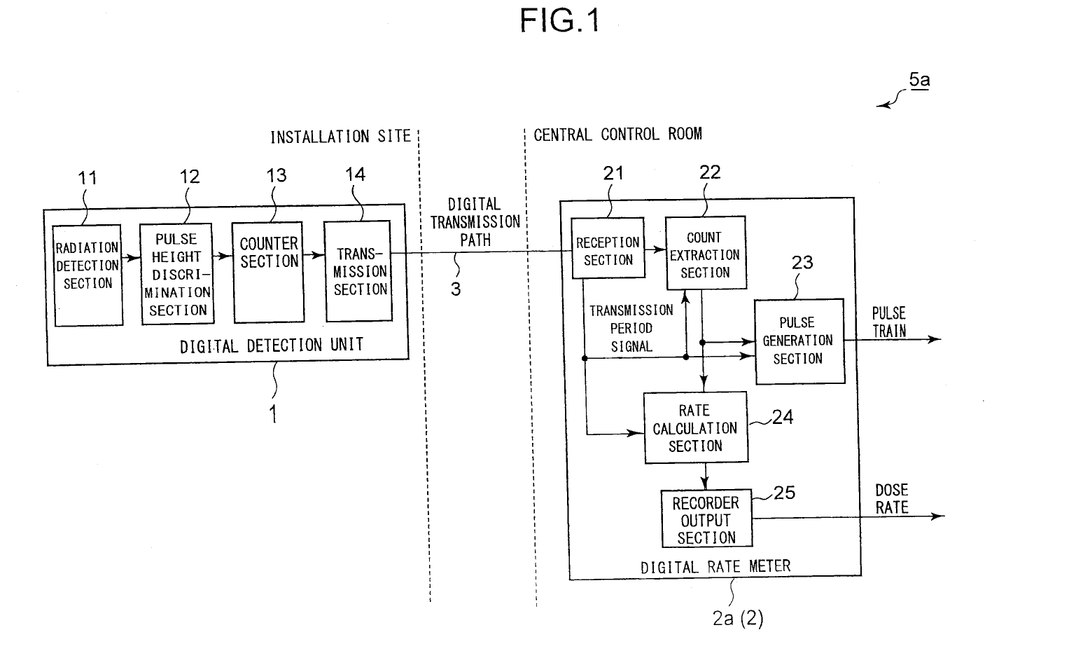

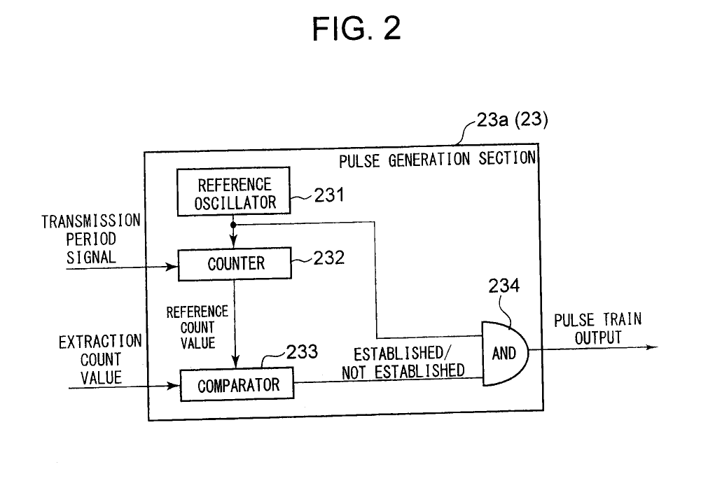

FIG. 1 is a block diagram illustrating a configuration of a first embodiment of a digital rate meter and a radiation monitoring system using the digital rate meter according to the present invention. FIG. 2 is a block diagram illustrating a configuration of a pulse generation section of FIG. 1.

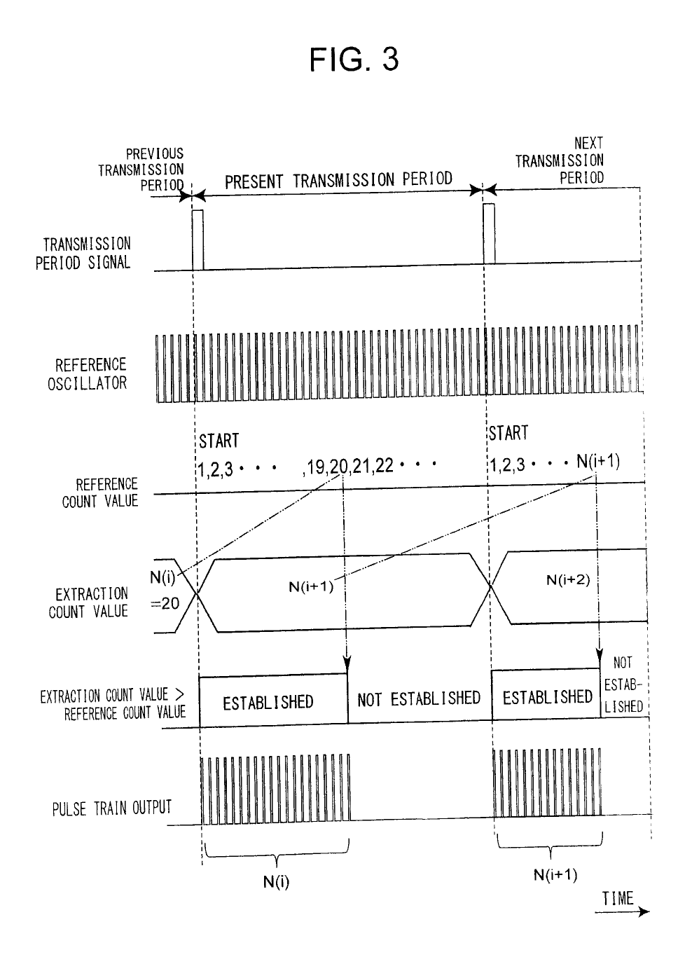

FIG. 3 is a diagram illustrating a control operation of the pulse generation section of FIG. 1.

As illustrated in FIG. 1, a radiation monitoring system 5a includes a digital detection unit 1, a digital rate meter 2a, and a digital transmission path 3 connecting the digital detection unit 1 and digital rate meter 2a.

The digital detection unit 1 is installed in a location where radiation may be emitted from plant equipment and detect the radiation around the installation site. A detector signal detected by the digital detection unit 1 and output therefrom is transmitted to the digital rate meter 2a installed in a central control room through the digital transmission path 3.

The digital transmission path 3 is a transmission path connecting the digital detection unit 1 and the digital rate meter 2a. The digital transmission path 3 may be a wired transmission path (metal cable, optical cable, etc.), a wireless transmission path, or a combination thereof. With this configuration, a transmission signal from the digital detection unit 1 is transmitted through the digital transmission path 3 and received by the digital rate meter 2a.

A configuration of the digital detection unit 1 will be described.

As illustrated in FIG. 1, the digital detection unit 1 includes a radiation detection section 11, a pulse height discrimination section 12, a counter section 13, and a transmission section 14.

The radiation detection section 11 senses the radiation and convert the sensed radiation into a detector signal having a voltage waveform proportional to energy thereof. The radiation detection section 11 is a detector that can detect radiation such as α-rays, β-rays, γ-rays, or neutrons. Specifically, the radiation detection section 11 may be a scintillator or an SSD (Solid State Detector: semiconductor detector).

The pulse height discrimination section 12 inputs thereto the detector signal converted by the radiation detection section 11 and makes pulse height discrimination of the input detector signal. The pulse height discrimination section 12 compares the input detector signal with a predetermined threshold level. When the detector signal exceeds the predetermined threshold level, the pulse height discrimination section 12 outputs a pulse (shapes the detector signal into a pulse). The pulse height discrimination section 12 may include, e.g., an amplifier circuit, a comparator, and the like (not shown).

The counter section 13 inputs thereto the pulse output from the pulse height discrimination section 12. The counter section 13 counts a pulse number of the input pulse. For example, the counter section 13 outputs a count value obtained by counting the pulse number for each constant period (transmission period) or a count value obtained by accumulating the pulse number for each constant period (transmission period). The counter section 13 outputs the counter value to the transmission section 14.

Upon reception of the counter value from the counter section 13, the transmission section 14 generates a transmission signal including the counter value. The transmission section 14 transmits the generated transmission signal to the digital rate meter 2a through the digital transmission path 3 for each transmission period. The transmission signal may include, e.g., packet data and may be modulated by the transmission section 14 such that it can be transmitted through the digital transmission path 3.

The following describes a configuration of the digital rate meter 2a.

As illustrated in FIG. 1, the digital rate meter 2a includes a reception section 21, a count extraction section 22, a pulse generation section 23, a rate calculation section 24, and a recorder output section 25.

The reception section 21 receives the transmission signal through the digital transmission path 3. The reception section 21 demodulates the received transmission signal. The reception section 21 outputs the demodulated transmission signal to the count extraction section 22. Moreover, the reception section 21 extracts a transmission period signal from the transmission signal. The reception section 21 outputs the extracted transmission period signal to individual functional sections of the digital rate meter 2a. This allows the functional sections to operate synchronized in time with each other based on the transmission period, as described later.

The count extraction section 22 extracts, for each of the transmission periods, the count value from the demodulated transmission signal. The count extraction section 22 outputs an extraction count value to the pulse generation section 23, the rate calculation section 24, and the like based on the extracted count value. The count value to be extracted is, e.g., a value corresponding to radiation count number detected for each transmission period, a value obtained by accumulating the count number within a given time range, or the like. The count value to be extracted may be a value corresponding to radiation count number detected for each transmission period or a value corresponding to a difference between the cumulative count numbers obtained for each transmission period. In the present embodiments, the value corresponding to radiation count number detected for each transmission period is used as the count value to be extracted, for example.

The pulse generation section 23 converts, for each transmission period, the received count value into a pulse train of a pulse number corresponding to the count value. The pulse generation section 23 outputs the obtained pulse train. Details of the pulse conversion section 23 will be described later.

The rate calculation section 24 receives the extraction count value output from the count extraction section 22 and performs rate calculation (time constant processing). The rate calculation section 24 calculates a real-time dose rate by the rate calculation. The rate calculation section 24 outputs the calculated real-time dose rate to the recorder output section 25.

The recorder output section 25 outputs a dose rate in a predetermined output form based on the real-time dose rate calculated by the rate calculation section 24. The predetermined output form is, e.g., an analog voltage output or a digital value proportional to the dose rate per unit time period.

The following describes the configuration (FIG. 2) and operation (FIG. 3) of the pulse generation section.

As illustrated in FIG. 2, the pulse generation section 23a (23) includes a reference oscillator 231, a counter 232, a comparator 233, and an AND circuit 234. The pulse generation section 23a is an example of the configuration of the pulse generation section 23 illustrated in FIG. 1.

The reference oscillator 231 generates a reference clock for the count extraction section 22 to generate the pulse train. The reference clock has a frequency sufficiently higher in resolution than the count number of the radiation per unit time period. The reference oscillator 231 oscillates a clock of, e.g., 1 MHz and outputs the oscillated clock as a reference clock in the pulse generation section 23.

For example, as illustrated in FIG. 2, the counter 232 receives the transmission period signal from the reception section 21. The counter 232 counts the reference clock output from the reference oscillator 231 for each transmission period obtained from the transmission period signal. As illustrated in FIG. 3, the counter 232 starts counting the reference clock at a timing based on the transmission period. After the start, the counter 232 successively outputs the count value of the reference clock (reference count value) to the comparator 233.

The comparator 233 inputs thereto, together with the reference count value, the extraction count value from the count extraction section 22 for each transmission period. The comparator 233 inputs thereto the extraction count value for each transmission period and before comparison between the two inputs (before start of operation of FIG. 3). Moreover, every time the comparator 233 obtains the transmission period signal, it resets the reference count value to zero and resumes the counting.

At comparison start time, the comparator 233 compares the reference count value and extraction count value. Only while “extraction count value>reference count value” is being established (that is, when the extraction count value is larger than the reference count value), the comparator 233 outputs a signal allowing output of the pulse train. On the other hand, while “extraction count value>reference count value” is not being established (that is, when the extraction count value is equal to or smaller than the reference count value), the comparator 233 outputs a signal not allowing output of the pulse strain.

For example, in the example of FIG. 3, the comparator 233 acquires an extraction count value N (i)=20 from the count extraction section 22 in a period immediately before the current period (i.e., the previous transmission period). The “i” is assumed to be a positive number representing an order. The comparator 233 compares the extraction count value N (i) with the reference count value at a start timing based on the current transmission period.

As a result, as illustrated in FIG. 3, in the current transmission period, the comparator 233 outputs, to the AND circuit 234, an establishment signal in a time period from a time when the comparison is started to a time before the reference count value becomes N (i)=20. For example, the comparator 233 outputs a HIGH (or “1” of two-valued levels (0, 1)) signal (establishment signal) to the AND circuit 234 only while “extraction count value>reference count value”.

Moreover, the comparator 233 outputs a failure signal to the AND circuit 234 in a time period from the time when the comparison is started to a time when the reference count value is equal to or larger than N (i). For example, when “extraction count value>reference count value” is not established, the comparator 233 outputs a LOW (or “0” of two-valued levels (0, 1)) signal (failure signal) to the AND circuit 234. The signal to be output here may assume a coded value, in addition to the two-valued level.

The AND circuit 234 performs AND operation of the reference clock and the output of the comparator 233. The AND circuit 234 outputs a result of the AND operation as a pulse train. For example, as illustrated in FIG. 3, in a time period when the comparator 233 outputs the HIGH signal (“Established”), the AND circuit 234 outputs a pulse train of N (i) pulses in the current transmission period. On the other hand, when the comparator 233 outputs the LOW signal (“Not-Established”), the AND circuit 234 does not output the pulse train.

The pulse generation section 23 repeatedly executes the above operation for each transmission period. For example, an extraction count value N (i+1) is used in the subsequent transmission period, and a pulse train of N (i+1) pulses is output. Thus, the pulse train is output from the pulse generation section 23 for each transmission period.

As described above, in the first embodiment, it is possible to output the count value of pulses that have passed through the transmission-side pulse height discrimination section from the reception-side digital rate meter as a pulse train. Moreover, the count value before rate calculation can be acquired from only one pulse height discrimination section. Thus, the same count value is used for calculation of the real-time dose rate and other calculations. Thus, it is possible to measure the radiation dose rate, radiation count value, and the like with accuracy.

### Second Embodiment

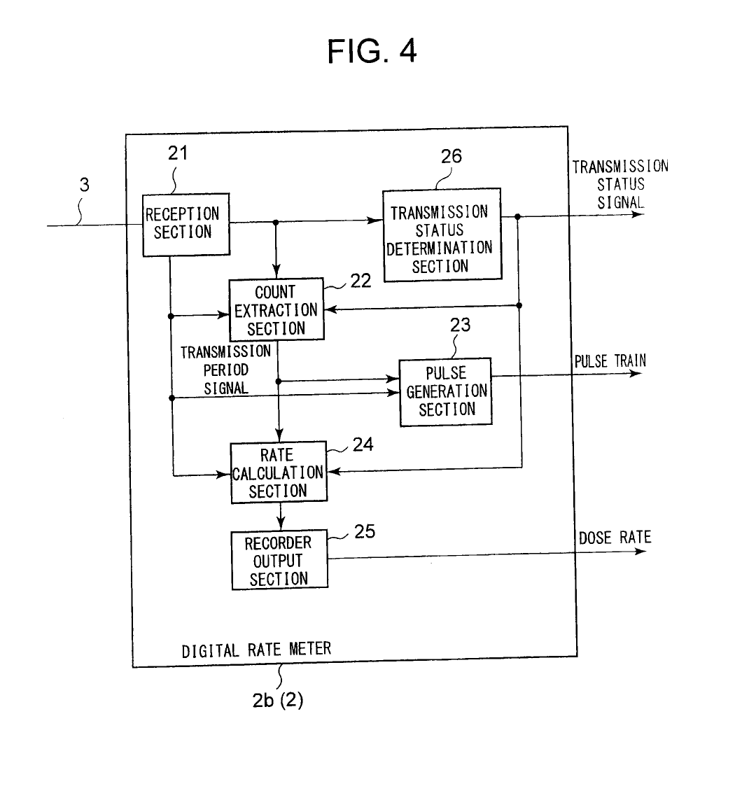

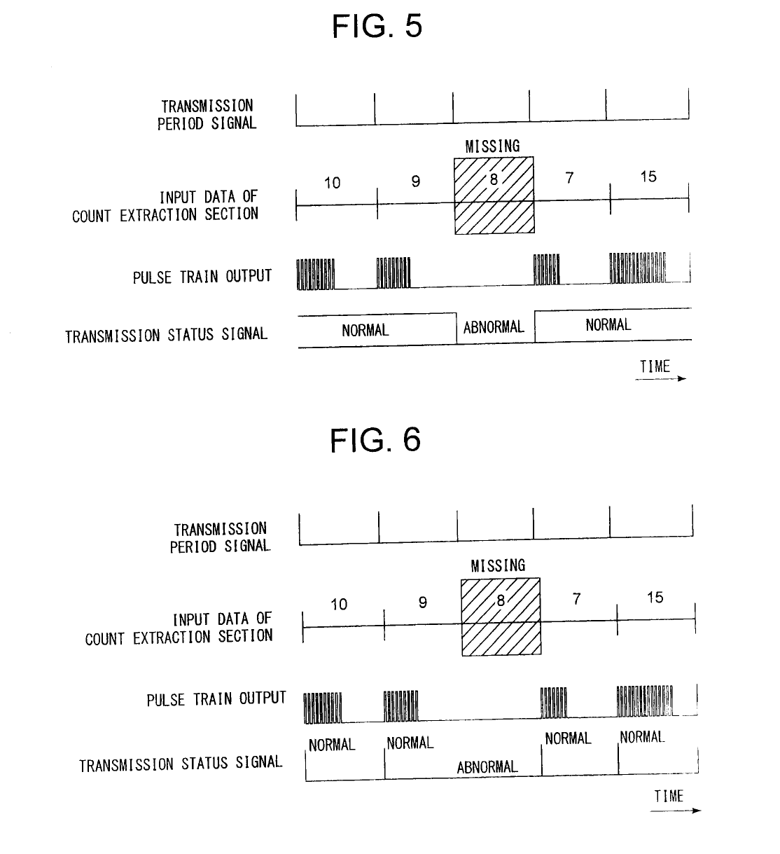

FIG. 4 is a block diagram illustrating a configuration of a second embodiment of the digital rate meter according to the present invention. FIG. 5 is a diagram illustrating an example of an output status of a transmission status determination section illustrated in FIG. 4. FIG. 6 is a diagram illustrating another example of the output status of the transmission status determination section illustrated in FIG. 4.

Illustration of the entire configuration of the radiation monitoring system according to the present embodiment is omitted, since it is similar to the configuration shown in FIG. 1. As can be seen from FIG. 4, the radiation monitoring system of the present embodiment differs from the radiation monitoring system 5a illustrated in FIG. 1 in that it includes a digital rate meter 2b in place of the digital rate meter 2a. Other configurations are the same as those illustrated in FIG. 1. Similarly, third and subsequent embodiments adopt the configuration of the radiation monitoring system 5a illustrated in FIG. 1 as a main configuration unless otherwise illustrated.

As illustrated in FIG. 4, the digital rate meter 2b further includes a transmission status determination section 26 in addition to the configuration of the digital rate meter 2a illustrated in FIG. 1.

In actual signal transmission, when reception data error occurs on the reception side due to fluctuation in the transmission period caused by time lag or fluctuation in a transmission interval between the transmission and reception sides or when a transmission signal error occurs due to failure of the digital transmission path 3, missing of reception data (including the count value) occurs.

In the present embodiment, there is provided the transmission status determination section 26 for determining a transmission status of the transmission signal received by the reception section 21 so as to monitor the missing of the reception data.

The transmission status determination section 26 inputs thereto the transmission signal from the reception section 21. The transmission status determination section 26 successively monitors the received signal and determines, for each transmission period, whether the transmission status is normal or abnormal. The transmission status determination section 26 outputs a result of the determination as a transmission status signal.

When the determined transmission status is normal, the transmission status determination section 26 outputs, as the transmission status signal, a “normal” state signal indicating normal. On the other hand, when the determined transmission status is abnormal, the transmission status determination section 26 outputs, as the transmission status signal, an “abnormal” state signal different from the “normal” state signal.

For example, when the transmission status is normal, the transmission status determination section 26 outputs a HIGH signal (“1”) as the normal state signal; when the transmission status is abnormal, the transmission status determination section 26 outputs a LOW signal (“0”) as the “abnormal” state signal.

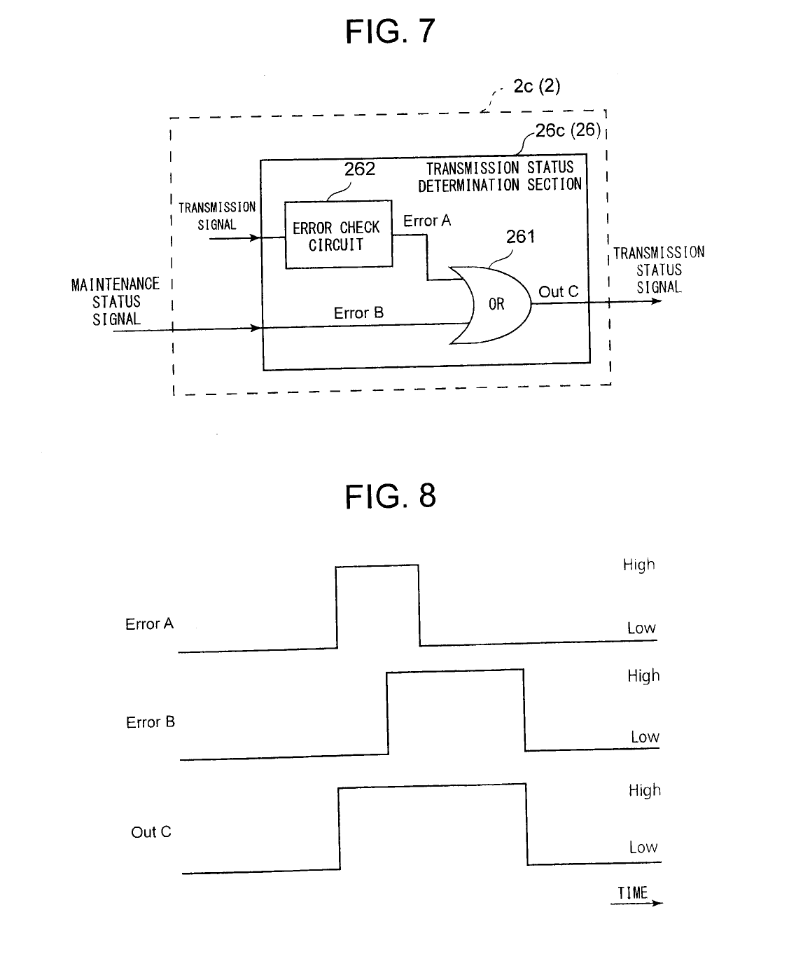

The transmission status determination section 26 has an error check function (e.g., an error check circuit illustrated in FIG. 7 to be described later) with respect to the transmission signal. The error check function checks, e.g., a CRC (Cyclic Redundancy Check) code or a parity check code. To this end, on the transmission side (e.g., in the transmission section 14), an error check code is added to the transmission signal. This allows the reception-side transmission status determination section 26 to check the error check code with respect to the transmission signal received for each transmission period. An example of the error check function will be described later using FIG. 7.

Although the reception section 21 and transmission status determination section 26 are provided separately in the example of FIG. 4, the reception section 21 may include the error check function (transmission status determination section 26).

When an error is present in the transmission signal, the transmission status determination section 26 outputs the “abnormal” state signal. On the other hand, when an error is absent in the transmission signal, the transmission status determination section 26 outputs the “normal” state signal.

The count extraction section 22 receives the transmission status signal from the transmission status determination section 26. When the received transmission status signal is the “normal” state signal, the count extraction section 22 extracts the count value from the transmission signal. On the other hand, when the received transmission status signal is the “abnormal” state signal, the count extraction section 22 does not extract the count value from the transmission signal.

As a result, for example, the count values of “10”, “9”, missing (actually, “8” is transmitted from the transmission side), “7”, and “15” are output for respective transmission periods as illustrated in FIG. 5. The count value for the missing period from the count extraction section 22 may be output as, e.g., “0”.

The pulse generation section 23 receives the “normal” state signal or “abnormal” state signal from the transmission status determination section 26. Then, the pulse generation section 23 converts the extraction count value output from the count extraction section 22 into a pulse train for each transmission period corresponding to the “normal” state signal. The pulse generation section 23 does not perform the conversion with respect to the transmission period corresponding to the “abnormal” state signal.

The transmission status determination section 26 illustrated in FIG. 4 uses an output method of the transmission status signal illustrated in FIG. 5 or FIG. 6. For simplification, the pulse numbers of respective pulse train outputs illustrated in FIGS. 5 and 6 are shown in the same transmission period as that corresponding to the input data of the count extraction section 22.

First, the output method of the transmission status signal illustrated in FIG. 5 will be described. For example, as illustrated in FIG. 5, it is assumed that input data including the count values of “10”, “9”, missing, “7”, and “15” is input to the count extraction section 22 for respective transmission periods. The pulse generation section 23 outputs a “pulse train output” corresponding to each count value for each transmission period.

Simultaneously, the transmission status determination section 26 outputs, for each transmission period, the HIGH signal when the transmission status signal is normal and the LOW signal when the transmission status signal is abnormal. As illustrated in FIG. 5, in the transmission period in which the input data of the count extraction section 22 is “missing”, the transmission status determination section 26 outputs the “abnormal” state signal as the transmission status signal.

As a result, in a case where a calculation unit is connected to the output of the digital rate meter 2b illustrated in FIG. 4, the calculation unit monitors a duration time of normal/abnormal state of the transmission status signal illustrated in FIG. 5 and can thus calculate the dose rate, density, and the like with accuracy.

Then, the output method of the transmission status signal illustrated in FIG. 6 will be described. In the example of FIG. 6, the transmission status determination section 26 outputs, for each transmission period, one pulse (e.g., one clock of the reference clock) when the transmission status signal is normal and does not output the one pulse when the transmission status signal is abnormal. Thus, it is possible to simplify a circuit configuration more in the output method of the transmission status determination section 26 illustrated in FIG. 6 in which the calculation unit counts the pulse number indicating normal than in the output method illustrated in FIG. 5 in which the calculation unit monitors the duration time of normal/abnormal of the transmission status signal.

As described above, when the missing of the reception data occurs, the pulse train is output as illustrated in FIG. 5 or 6. On the other hand, a time for accumulating the count value is constant irrespective of presence/absence of the missing. Thus, when the count value is calculated based on the time including the missing period, the cumulative value of the count value is smaller than a value obtained by accumulating the number of pulses that have actually passed through the pulse height discrimination section of the detector, resulting in underestimation of the dose rate or density.

According to the second embodiment, it is possible to monitor the presence/absence of the missing period by using the above-described transmission status signal and to correctly acquire the accumulating time in the presence of the missing period by excluding the missing period. This allows the calculation unit that calculates the radiation density can correct the accumulating time for the count value, thereby measuring the dose rate, density, and the like with accuracy.

### Third Embodiment

FIG. 7 is a block diagram illustrating a configuration of the transmission status determination section in a third embodiment of the digital rate meter according to the present invention. FIG. 8 is a diagram illustrating an example of a processing operation to be performed by the transmission status determination section illustrated in FIG. 7.

A digital rate meter 2c illustrated in FIG. 7 includes a transmission status determination section 26c in place of the transmission status determination section 26 of the digital rate meter 2b illustrated in FIG. 4, and illustration of other common functional sections is omitted.

The transmission status determination section 26c inputs thereto from outside the digital rate meter 2c a maintenance status signal indicating whether a maintenance status is active or not. When the maintenance status is active, the transmission status determination section 26c determines that the transmission status is abnormal for the transmission signal input for each transmission period. When the maintenance status is not active, the transmission status determination section 26c makes a determination based on the transmission status.

A state where the maintenance status is active is a state where maintenance is required in a period of a maintenance work or servicing work for the radiation monitoring system or its associated facilities. Thus, such maintenance is required, the maintenance active signal is output from an external signal sending device as an identifiable signal.

The transmission status determination section 26c may have an OR circuit 261 and an error check circuit 262, for example, as shown in FIG. 7.

The error check circuit 262 inputs thereto the transmission signal output from the reception section 21. The error check circuit 262 performs error check for the transmission signal. The error check circuit 262 checks, e.g., a CRC code or a parity check code included in the transmission signal. To this end, the transmission section 14 adds an error check code to the transmission signal, for example. This allows the reception-side transmission status determination section 26c to check the error check code with respect to the transmission signal received for each transmission period and thus to determine a state of the transmission signal.

The OR circuit 261 is a circuit for calculating logical OR of inputs. For example, the OR circuit 261 inputs thereto a result of the check made by the error check circuit 262 and a maintenance status signal. The OR circuit 261 outputs the transmission status signal as abnormal when at least one of the inputs is an abnormal signal and, otherwise, outputs the transmission status signal as normal.

For example, when an Error A signal (output from the error check circuit 262) illustrated in FIGS. 7 and 8 is HIGH (“1”), it is determined that an error is present (abnormal) in the transmission signal. Similarly, when an Error B signal (maintenance status signal) is HIGH (“1”), it is determined that the maintenance status is active. As a result, when at least one of the Error A signal and Error B signal input to the OR circuit 261 is HIGH, an output (Out C signal) of the OR circuit 261 is HIGH. That is, the transmission status signal is output as the “abnormal” state signal. Otherwise, the Out C signal of the OR circuit 261 is LOW. That is, the transmission status signal is output as the “normal” state signal.

As described above, according to the third embodiment, even when measurement cannot be performed due to maintenance in addition to the missing of the reception data due to reception error, a signal allowing determination of whether the transmission status is normal or abnormal can be output outside the digital rate meter by the transmission status determination section. This allows a measurement value obtained while the transmission status is abnormal to be excluded, thereby allowing the radiation dose rate, radiation count value, and the like to be measured with accuracy.

### Fourth Embodiment

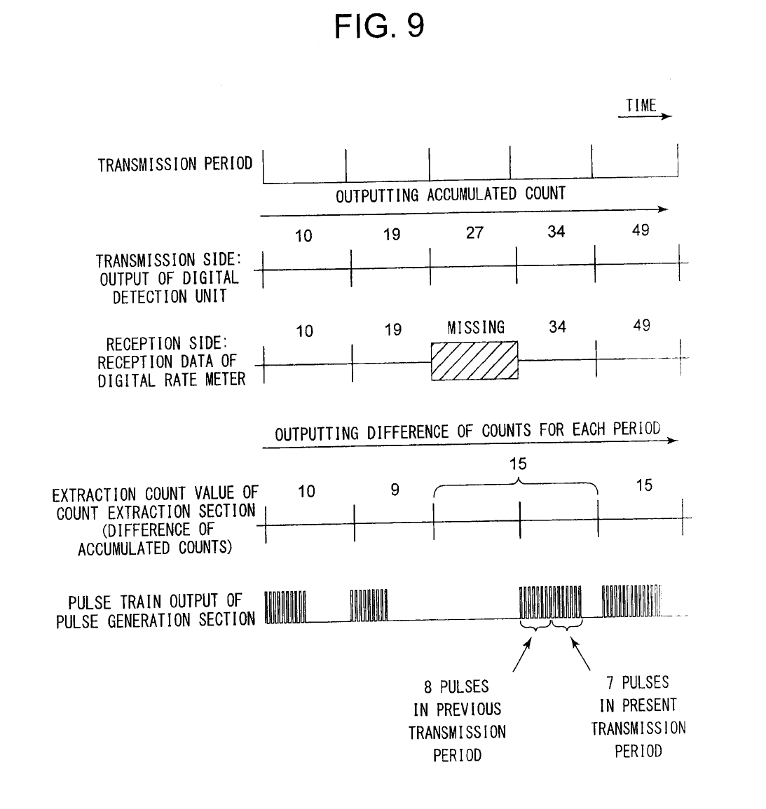

FIG. 9 is a diagram illustrating a count value extraction operation in a fourth embodiment of the digital rate meter according to the present invention.

The digital rate meter of the fourth embodiment has the same configuration as that of the digital rate meter 2a illustrated in FIG. 1, and the digital detection unit 1 to be described below has the same configuration as that illustrated in FIG. 1. Moreover, the count value extraction operation of the functional sections described below is performed according to the procedure illustrated in FIG. 9.

The digital detection unit 1 starts accumulating the count value of detected radiation and transmits, for each transmission period, the transmission signal including the cumulative count value to the digital rate meter 2a.

The count extraction section 22 calculates, for each transmission period, a difference between the count value extracted in one transmission period and the count value extracted in the previous transmission period. The count extraction section 22 outputs the calculated difference as the extraction count value.

The count accumulation period is determined by the counter section 13. As illustrated in FIG. 9, the counter section 13 accumulates, for each count accumulation period which is longer than the transmission period, the count value of the detected radiation. The transmission signal including the cumulative count value is transmitted to the digital rate meter 2a for each transmission period. The transmission period is a period in which the cumulative count value is transmitted on the transmission signal.

The output of the digital detection unit 1 is transmitted on the transmission signal from the transmission section 14 as the count value (cumulative count value) counted and accumulated by the counter section 13, as illustrated in FIG. 9. For example, as illustrated in FIG. 9, a transmission signal including the count values of “10”, “19”, “27”, “34”, and “49” is output from the transmission side as the output of the digital detection unit 1.

The reception data of the digital rate meter 2a is the cumulative count value included in the transmission signal received by the reception section 21. For example, as illustrated in FIG. 9, a transmission signal including count values of “10”, “19”, missing, “34”, “49” is received by the reception side as the reception data of the digital rate meter 2a. That is, in the transmission period corresponding to the missing, there occurs a state where an error or the like has occurred in the transmission signal to disable reproduction of the reception data.

The extraction count value of the count extraction section 22 is a value corresponding to a difference between the count value (cumulative count value) extracted for the present transmission period by the extraction section 22 and the count value (cumulative count value) extracted in the previous transmission period. For example, as illustrated in FIG. 9, as the extraction count value, differences between the cumulative count values of “10”, “9”, “15”, and “15” are output as the extraction count value. For simplification, the pulse numbers of respective pulse train outputs illustrated in FIG. 9 are shown in the same transmission period as that corresponding to the extraction count value of the count extraction section 22.

The pulse train output of the pulse generation section 23 is a pulse train of a pulse number corresponding to the extraction count value extracted for each transmission period. In the transmission period corresponding to the missing, no pulse train is output. However, in a normal transmission period following the transmission period corresponding to the missing, a pulse train corresponding to the difference between the cumulative counter values can be output.

For example, as illustrated in FIG. 9, when the transmission period corresponding to the missing is present, “15” is output, in the subsequent normal transmission period, as the extraction count value of the count extraction section 22 corresponding to a difference between the cumulative count values included in the reception data in the transmission periods before and after the transmission period corresponding to the missing. That is, the extraction count value including a difference count value “8” in the transmission period corresponding to the missing and a difference count value “7” in the subsequent normal transmission period is output. That is, even when the transmission period corresponding to the missing is present, the cumulative count value is included in the reception data on a continuing basis.

In the first to the third embodiments, the digital detection unit 1 transmits, as the count value, the count number detected for each transmission period. However, in the present embodiment, the cumulative count number in a predetermined period is transmitted from the digital detection unit 1 as the count value (cumulative count value).

As a result, as illustrated in FIG. 9, even when there occurs the missing of reception data, it is possible to output a correct cumulative count number by including the count value corresponding to the missing in the subsequent normal transmission period based on the cumulative count numbers in the transmission periods before and after the transmission period corresponding to the missing. As a result, even when the accumulating time including the missing period is used, the dose rate, density, and the like can be calculated with accuracy.

As described above, according to the fourth embodiment, even when there occurs the missing of the reception data of the digital rate meter, the count value is extracted in the form of the cumulative count number, so that it is possible to acquire a correct count number even when the missing period is included. As a result, the radiation dose rate, radiation count value, and the like can be measured with accuracy.

### Fifth Embodiment

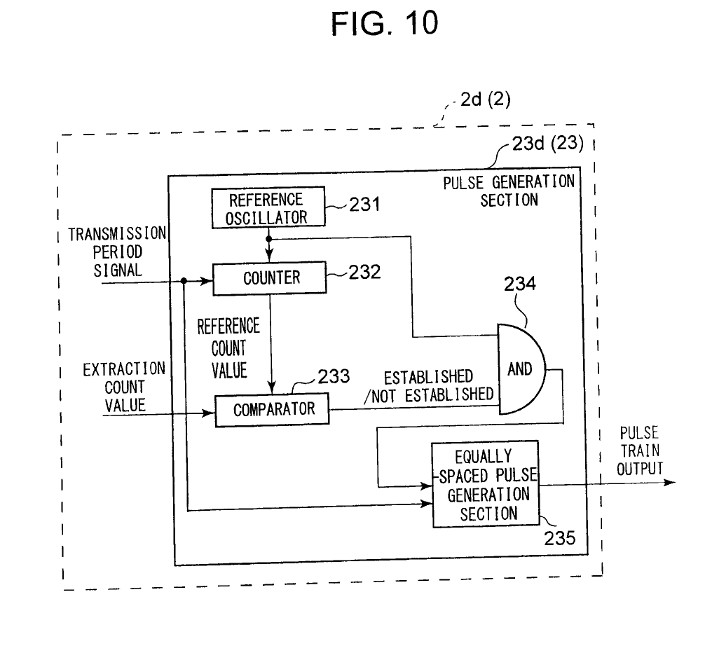

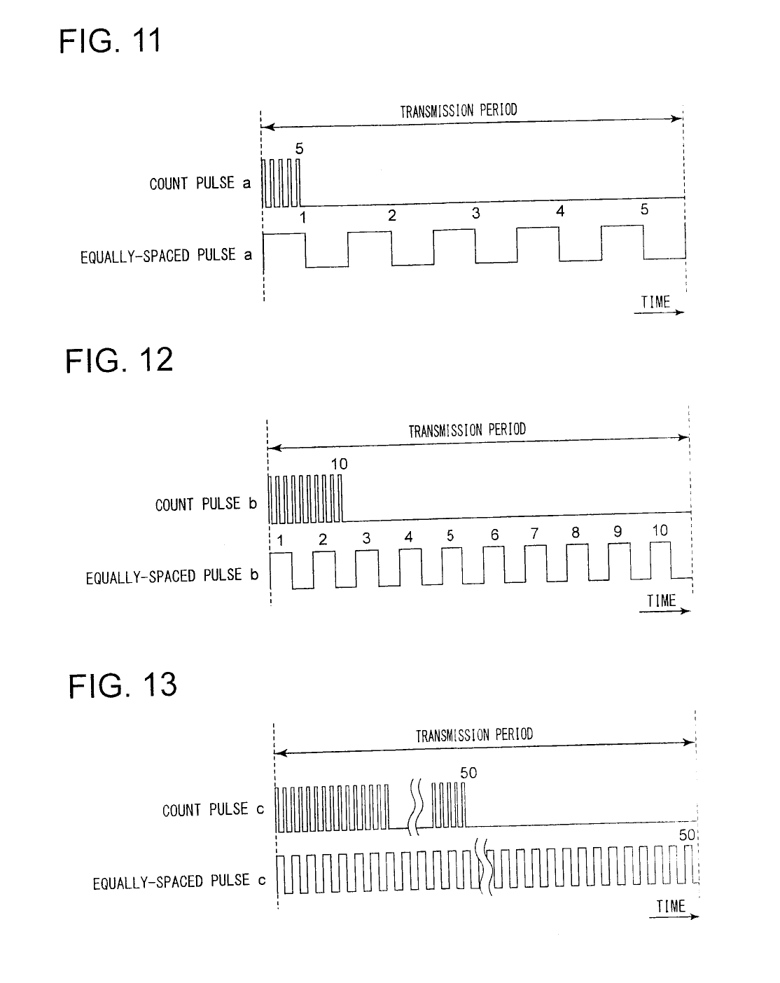

FIG. 10 is a block diagram illustrating a configuration of the pulse generation section in a fifth embodiment of the digital rate meter according to the present invention. FIGS. 11, 12, and 13 are each a diagram illustrating a control operation to be performed by the pulse generation section illustrated in FIG. 10. The configuration of a digital rate meter 2d (2) illustrated in FIG. 10 is the same as that illustrated in FIG. 1, and illustration of configurations other than a pulse generation section 23d (23) is omitted.

The pulse generation section 23d converts, for each transmission period, the count value extracted by the count extraction section 22 into an equally-spaced pulse train corresponding to a time width of the transmission period.

In the first embodiment, the pulse width of the pulse train to be output from the pulse generation section 23a illustrated in FIG. 2 is fixed. That is, as illustrated in FIG. 3, the pulse width of the pulse train is determined by the pulse width of the reference clock of the reference oscillator 231 of the pulse generation section 23a. Thus, depending on the specification of the external measuring instrument such as a counter to be connected to the reception side, there may occur a case where a frequency (especially, high frequency) of the reference clock cannot be measured accurately.

In a case where a plurality of different devices are connected, for example, when an external counter is connected to the output of the pulse generation section 23a illustrated in FIG. 2 so as to measure the count value, it is necessary to take into consideration the specification of the external counter to be used on the reception side.

Thus, in the fifth embodiment, when the pulse train is output from the pulse generation section 23d illustrated in FIG. 10, the pulse width of the pulse train is not fixed by the pulse width of the reference clock, but an equally-spaced pulse train corresponding to the time width of the transmission period is output. That is, in the present embodiment, the pulse width is made larger within the transmission period to output a pulse train of a lower frequency.

The following describes the configuration of the pulse generation section 23d illustrated in FIG. 10, and then describes a control operation to be performed by the pulse generation section 23d illustrated in each of FIGS. 11, 12, and 13.

The transmission signal transmitted from the digital detection unit 1 is received by the reception section 21 of the digital rate meter 2d, and the count value is extracted from the received transmission signal by the count extraction section 22. Based on the extracted count value, the count extraction section 22 outputs an extraction count value to the pulse generation section 23d. Moreover, the reception section 21 outputs the transmission period signal to the pulse generation section 23d and the like.

Based on the transmission period signal, extraction count value, reference clock output from the reference oscillator 231, the pulse generation section 23d outputs, from the AND circuit 234, a pulse train corresponding to the extraction count value to an equally-spaced pulse generation section 235.

The equally-spaced pulse generation section 235 adjusts, for each transmission period, the pulse width (pulse period) of the pulse train input from the AND circuit 234 in accordance with the pulse number thereof.

Specifically, as illustrated in FIG. 11, the equally-spaced pulse generation section 235 outputs equally-spaced pulses “a” obtained by adjusting a width of each of count pulses “a” (five counts) within a predetermined period (transmission period). It is assumed here that the reference clock and the transmission frequencies are 1 MHz and 10 Hz, respectively. Accordingly, the count pulses “a” include five pulses in each transmission period (0.1 sec) and each pulse has a pulse width corresponding to frequency of 1 MHz. On the other hand, the equally-spaced pulses “a” adjusted within a transmission time (0.1 sec) of one transmission period corresponding to the frequency of 10 Hz includes five pulses, and each pulse has a pulse width corresponding to frequency of 50 Hz.

Similarly, as illustrated in FIG. 12, the equally-spaced pulse generation section 235 outputs equally-spaced pulses “b” (e.g., 100 Hz pulse) obtained by adjusting a width of each of count pulses “b” (ten counts) within a predetermined period. Moreover, as illustrated in FIG. 13, the equally equally-spaced pulse generation section 235 outputs equally-spaced pulses “c” (e.g., 500 Hz pulse) obtained by adjusting a width of each of count pulses “c” (50 counts) within a predetermined period.

That is, the equally-spaced pulse generation section 235 generates the equally-spaced pulses in accordance with the extraction count value within one transmission period.

As described above, according to the fifth embodiment, in the pulse train output for radiation counting, the pulse width can be adjusted within the transmission period. This allows output of the pulse train at a lower frequency, thereby widening a specification range of an external measuring instrument to be applied for radiation counting.

### Sixth Embodiment

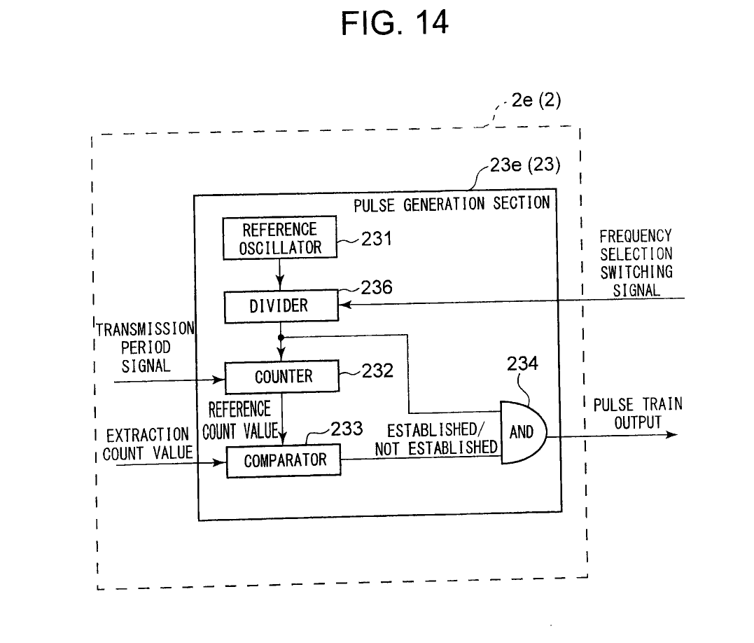

FIG. 14 is a block diagram illustrating a configuration of the pulse generation section in a sixth embodiment of the digital rate meter according to the present invention. The configuration of a digital rate meter 2e (2) illustrated in FIG. 14 is the same as that illustrated in FIG. 1, and illustration of configurations other than a pulse generation section 23e (23) is omitted.

The pulse generation section 23e differs from the pulse generation section 23d illustrated in FIG. 10 in that it does not include the equally-spaced pulse generation section 235 but instead includes a divider 236 between the reference oscillator 231 and the counter 232.

The pulse generation section 23d illustrated in FIG. 10 converts, for each transmission period, the count value extracted by the count extraction section 22 into the equally-spaced pulse train corresponding to the time width of the transmission period.

On the other hand, the pulse generation section 23e illustrated in FIG. 14 uses the divider 236 to divide the reference clock output from the reference oscillator 231. The divider 236 can select one of a plurality of division ratios by receiving an external frequency selection switching signal. The division ratios may be, e.g., 1/1 (1), 1/2, 1/10, 1/16, 1/100, and 1/256. The division ratio range may be determined considering a frequency range of the reference clock and the specification range of a measuring instrument provided on the reception side.

For example, assume that there are provided, as an external measuring instrument such as a counter to be connected to the reception side device (digital rate meter), a device A (not illustrated) that can measure up to 10 MHz, a device B (not illustrated) that can measure up to 400 kHz, and a device C (not illustrated) that can measure up to 20 kH.

Assuming that a frequency of the reference clock is 1 MHz, the pulse train output to be output from the pulse generation section 23a illustrated in FIG. 2 has a pulse width in which one pulse is set to 1 MHz. Thus, although the device A can be used for measurement, the devices B and C cannot be used due to insufficient specification.

On the other hand, the pulse generation section 23e illustrated in FIG. 14 can divide the reference clock of 1 MHz output from the reference oscillator by using the divider 236. As a result, a user can externally select a division ratio of 1 for the device A, a division ratio of 1/4 for the device B, and a division ratio of 1/100 for the device C. Thus, depending on the specification of an external measuring instrument such as a counter to be connected to the reception side, the pulse train output can be output at a lower frequency than the frequency of the reference clock.

As the pulse generation section 23e shown in FIG. 14 includes the divider 236, the circuit becomes simpler than that of the pulse generation section 23d in FIG. 10.

As described above, according to the sixth embodiment, in the pulse train output for radiation counting, the pulse width can be adjusted within the transmission period in response to the frequency selection from outside. This allows output of the pulse train at a lower frequency, thereby widening a specification range of an external measuring instrument to be applied for radiation counting.

### Seventh Embodiment

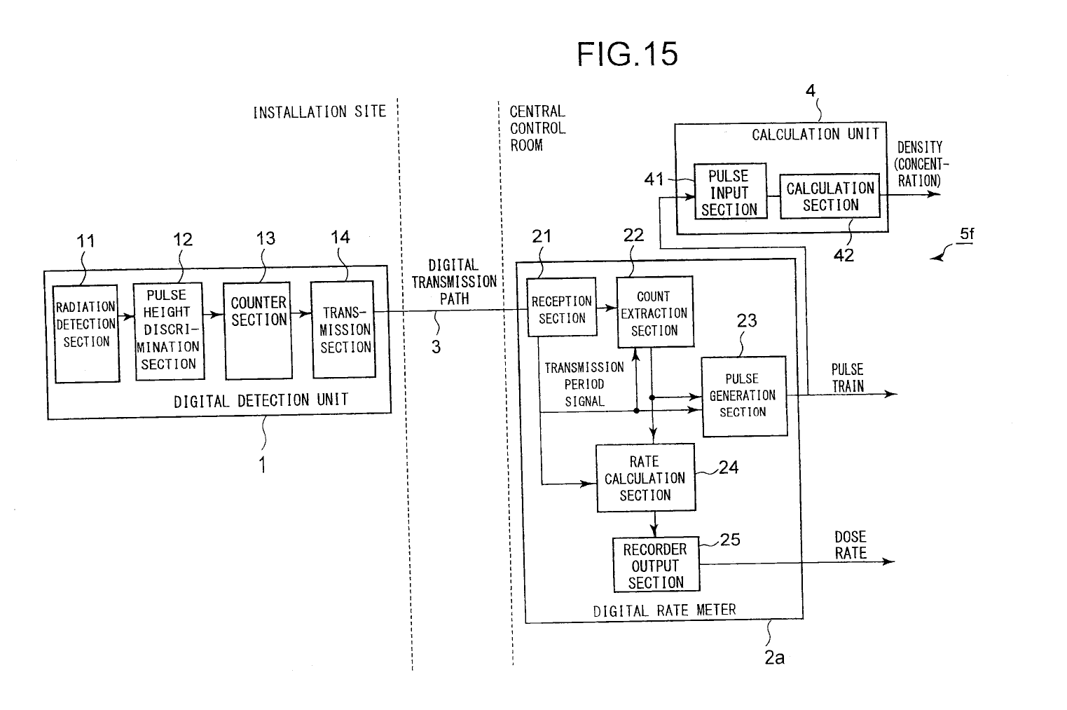

FIG. 15 is a block diagram illustrating a configuration of another embodiment of the radiation monitoring system using the digital rate meter according to the present invention. The digital rate meter according to the seventh embodiment is used in a radiation monitoring system 5f illustrated in FIG. 15.

As illustrated in FIG. 15, the radiation monitoring system 5f includes the digital detecting unit 1, digital rate meter 2a, and a calculation unit 4. The calculation unit 4 includes a pulse input section 41 and a calculation section 42. The configurations of the digital detecting unit 1 and digital rate meter 2a are the same as those described in the first embodiment.

The pulse input section 41 inputs thereto the pulse train output that is output from the digital rate meter 2a.

The calculation section 42 converts the pulse train output into the count value and calculates the radiation density using the count value (reproduction count value) after conversion.

In general, the radiation density (concentration) can be calculated by the following equation:

(Radiation Density)=(Count value per unit time)×(Conversion factor)/(Volume).

The conversion factor mentioned here differs depending on the object to be measured and indicates an inverse number of detection efficiency in a measurement system.

The radiation monitoring system 5f converts the pulse train obtained in the digital detection unit 1 and the digital rate meter 2a into the count value (numerical value). The obtained count value is used for calculation of the radiation density to be performed by the calculation section 42 of the calculation unit 4.

Moreover, the calculation section 42 can calculate a counting rate by the following equation:

(Counting rate)=(Cumulative count)/(Measurement time).

The calculated counting rate may be used for calculation of the above-mentioned detection efficiency to be performed by the calculation unit 4.

As a result, it is possible to perform calculation of the radiation density by the use of the same count value (reproduction count value) as the real-time dose rate.

As described above, according to the seventh embodiment, it is possible to output the count value of pulses that have passed through the pulse height discrimination section of the transmission-side digital detecting unit as a pulse train, from the reception-side digital rate meter.

That is, according to the present embodiment, the count value before rate calculation can be acquired from only one pulse height discrimination section, and thus the same count value having no difference is used for calculation of the radiation density and other calculations. (Two pulse height discrimination sections are used in the configuration of FIG. 16, but only a single pulse height discrimination section is used in this embodiment. Thus, it is possible to measure the radiation dose rate, radiation count value, and the like with accuracy.

### Other Embodiments

Although the preferred embodiments of the present invention have been described above, the embodiments are merely illustrative and do not limit the scope of the present invention. For example, individual features of the embodiments may be combined with one another. Moreover, the embodiments may be practiced in other various forms, and various omissions, substitutions and changes may be made without departing from the scope of the invention. The embodiments and modifications thereof are included in the scope or spirit of the present invention and in the appended claims and their equivalents. Moreover, although plant equipment is taken as an application example of the above embodiments, it goes without saying that the embodiments may be applied to other equipment for use in monitoring the radiation.

What is claimed is:

1. A digital rate meter communicably connected to a digital detection unit that measures radiation based on a detector signal output from a radiation detector and transmits, for each transmission period, a transmission signal including a count value, the digital rate meter comprising:
a reception section that receives the transmission signal including the count value;
a count extraction section that extracts, for each transmission period, the count value from the transmission signal received by the reception section and outputs an extraction count value based on the extracted count value;
a pulse generation section that converts, for each transmission period, the extraction count value output from the count extraction section into a pulse train of a corresponding pulse number and outputs the obtained pulse train;
a rate calculation section that performs rate calculation based on the extraction count value to calculate a dose rate; and
a recorder output section that outputs the dose rate in a predetermined output form.

2. The digital rate meter according to claim 1, further comprising a transmission status determination section that inputs thereto the transmission signal from the reception section and monitors the input transmission signal to determine, for each transmission period, whether a transmission status is normal or abnormal, wherein
the transmission status determination section outputs a normal state signal indicating a normal state when the determined transmission status is normal, while outputs an abnormal state signal different from the normal state signal when the determined transmission status is abnormal.

3. The digital rate meter according to claim 2, wherein
the pulse generation section receives, for each transmission period, the normal state signal or abnormal state signal from the transmission status determination section, and outputs the pulse train when receiving the normal state signal, while does not output the pulse train when receiving the abnormal state signal.

4. The digital rate meter according to claim 2, wherein
the transmission status determination section further inputs thereto from outside the digital rate meter a maintenance status signal indicating whether a maintenance status is active or not, and determines that the transmission status is abnormal for the input transmission signal when the maintenance status is active, while makes determination on whether the transmission status is normal or abnormal based on the transmission status when the maintenance status is not active.

5. The digital rate meter according to claim 1, wherein
the count value included in the transmission signal transmitted from the digital detection unit is a value obtained by measuring, for each predetermined time, the radiation and accumulating the measured value, and
the count extraction section calculates a difference between the count value extracted in one transmission period and count value extracted in previous transmission period and outputs, for each transmission period, the calculated difference as the extraction count value.

6. The digital rate meter according to claim 1, wherein
the pulse generation section converts the extraction count value into an equally-spaced pulse train corresponding to a time width of the transmission period.

7. The digital rate meter according to claim 1, wherein
the pulse generation section includes: a reference oscillator that outputs a reference clock, and a divider that selectively switches a plurality of division ratios of the reference clock, and
the pulse generation section uses a reference clock obtained by dividing the reference clock output from the reference oscillator based on one of the plurality of division ratios to convert the extraction count value into the pulse train corresponding to the reference clock after the division.

8. A radiation monitoring system comprising:
a digital detection unit that detects radiation and measures the radiation; and
a digital rate meter to be communicably connected to the digital detection unit, wherein
the digital detection unit includes:
a radiation detection section that detects the radiation and outputs the detected radiation in a form of a detector signal;
a pulse height discrimination section that shapes, based on the detector signal output from the radiation detection unit, the detector signal having a level exceeding a predetermined threshold level into a pulse and outputs the pulse;
a counter section that counts the number of pulses output from the pulse height discrimination section; and
a transmission section that transmits a transmission signal including a count value counted for each transmission period, and
the digital rate meter includes:
a reception section that receives the transmission signal including the count value;
a count extraction section that extracts, for each transmission period, the count value from the transmission signal received by the reception section and outputs an extraction count value based on the extracted count value;
a pulse generation section that converts, for each transmission period, the extraction count value output from the count extraction section into a pulse train of a corresponding pulse number and outputs the obtained pulse train;
a rate calculation section that performs rate calculation based on the extraction count value to calculate a dose rate; and
a recorder output section that outputs the dose rate in a predetermined output form.

9. The radiation monitoring system according to claim 8, further comprising a calculation unit that includes:
a pulse input section that inputs thereto the pulse train output from the pulse generation section and converts the pulse train into a reproduction count value, and
a calculation section that uses the reproduction count value to perform calculation of radiation density.
